(19) United States
(12) Patent Application Publication
(10) Pub. No.: US 2006/0026595 A1
(43) Pub. Date: Feb. 2, 2006

(54) Workflow management apparatus, workflow management program, and workflow management method

(75) Inventors: Noriyasu Nakayama, Kawasaki (JP); Yutaka Awata, Kawasaki (JP); Nobukazu Koizumi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/003,462

(22) Filed: Dec. 6, 2004

(30) Foreign Application Priority Data
Jul. 29, 2004 (JP) 2004-222035

(51) Int. Cl. G06F 9/46

(52) U.S. Cl. 718/100

(57) ABSTRACT

A workflow management apparatus that manages a plurality of processes constituting a workflow, comprises: an I/O information acquisition unit 13 that acquires I/O information defining, in each of the processes, output data obtained as a processing result and input data serving as the data related to processing; a process management unit 14 that allows each of the processes to perform processing based on input data of a currently acquired version number; a version number acquisition unit 15 that acquires information related to version numbers of the input and output data handled in each of the processes; and a state registration unit 11 that registers the state of each of the processes, wherein when the output data in any of the processes is updated, the state registration unit resisters the state of the process including the updated output data in the input data thereof as “Being executed” based on the information related to the acquired I/O information and version number.

### BACKGROUND OF THE INVENTION

1. Field of the Invention

The present invention relates to a workflow management apparatus that automates a management task needed for carrying out a task involving a workflow, and more particularly, to a workflow management apparatus, workflow management program and a workflow management method suitable for carrying out a task involving high-level parallel operations.

2. Description of the Related Art

In many tasks whose workflow can be generalized to some extent, it is possible to realize improvement in operational efficiency, reduction in miss rate, and correct understanding of the progress by allowing computerized information to be automatically distributed along the generalized workflow. The system like this is referred to as a workflow management system.

Conventionally, techniques that manage version number of the data utilized in a series of operation have been disclosed (refer, for example, to Jpn. Pat. Appln. Laid-Open Publication No. 7-93387 (pages 4 to 8, FIG. 1), Pat. Jpn. Pat. Appln. Laid-Open Publication No. 8-147333 (pages 3 to 4, FIG. 1), Jpn. Pat. Appln. Laid-Open Publication No. 2000-76357 (pages 4 to 6, FIG. 1), and Jpn. Pat. Appln. Laid-Open Publication No. 2001-109786 (pages 4 to 8, FIG. 1)). For example, there has been a system that combines a workflow management and a function of managing the version number of the data utilized in each process in the workflow to keep the version number of the data generated throughout the entire workflow up to date, in which when a part of data has been updated and data that does not conform to dependency relationship between data is generated, the system issues a notification that prompts a person in charge to cope with the problem, thereby eliminating the problem related to dependency relationship between data.

The above conventional technique related to the workflow management system has been mainly applied to the task such as customer claim management or leave application process for employee, in which processes are executed in sequential order and parallel operations are not generated in the same workflow, or the technique could not have handled high-level parallel operations (to be described later) such as hardware design.

Like the case of the hardware design, there is a task that intends to achieve improvement in operational efficiency by high-level parallel operations in which, for example, while design specification is created in design specification creation process, procedure is allowed to go ahead based on temporary design specification in design process which lies downstream of the design specification creation process, that is, consecutive processes on the upstream and downstream sides are allowed to go ahead simultaneously.

In the abovementioned task involving high-level parallel operations, a method in which examination with respect to a succeeding process is brought forward with an older version design specification intentionally allowed to be distributed has been used in some cases. In other words, the operation in the task is advanced with inconsistency in the version numbers of the data handled in the preceding and succeeding processes known.

In this case, it is impossible to cope with the inconsistency in the version numbers of the data handled in the consecutive processes on the upstream and downstream sides only by simultaneously executing a plurality of processes in the same workflow using the above technique according to the prior art to enable the parallel operations. As described above, it has been difficult to solve the problem related to the inconsistency in the version numbers of the data handled between processes.

In the case of managing a workflow of the task involving the abovementioned high-level parallel operations, a project manager must collect scattered data by him or herself and control an operation flow while referring to the collected data for direction. Therefore, there has been a need to increase in operational efficiency.

### SUMMARY OF THE INVENTION

The present invention has been made to solve the above problems, and an object thereof is to provide a workflow management apparatus, workflow management program and a workflow management method that can contribute to automatization of the management task and increase in operational efficiency in the task involving high-level parallel operations.

To solve the above problems, according to a first aspect of the present invention, there is provided a workflow management apparatus that manages a plurality of processes constituting a workflow, including: an I/O information acquisition unit that acquires I/O information defining, in each of the processes, output data obtained as a processing result and input data serving as the data related to processing; a process management unit that allows each of the processes to perform processing based on input data of a currently acquired version number; a version number acquisition unit that acquires information related to version numbers of the input and output data handled in each of the processes; and a state registration unit that registers the state of each of the processes, wherein when the output data in any of the processes is updated, the state registration unit resisters the state of the process including the updated output data in the input data thereof as “Being executed” based on the information related to the acquired I/O information and version number.

Thus, each of the processes is allowed to perform processing based on input data of a currently acquired version number, so that it is possible to realize workflow management that performs high-level parallel operations in which consecutive processes on the upstream and downstream sides are allowed to go ahead simultaneously. Further, it is possible to flexibly cope with the case where inconsistency is present in the version numbers of the data used between processes, contributing to automatization of the management task and increase in operational efficiency in the task involving high-level parallel operations.

In the workflow management apparatus having the above configuration, it is preferable that the process management unit complete the entire processing of the workflow only when the version number of the output data in each process and the version number of the input data corresponding to the output data in the process that includes the output data as input data correspond to each other.

With this configuration, even when processing of each process is advanced with inconsistency in the version number of the output data and the version number of the input data corresponding to the output data in the process that uses the output data as input data known, it is possible to assure consistency between the version numbers in each process throughout the workflow in the last result.

Further, in the workflow management apparatus having the above configuration, when the output data in any of the processes is updated, the state registration unit may correspondingly update for registration the input data corresponding to the updated output data in the process that uses the updated output data as input data.

With this configuration, even when the version number of the output data is updated in the process that lies on the upstream side of the workflow, it is possible to always keep the input data of the process that uses the updated output data as input data up to date. As a result, information related to design change or the like can be quickly reflected in the process on the downstream side, contributing to improvement in operational efficiency.

In the workflow management apparatus having the above configuration, the process management unit may allow an arbitrary process to use previous version output data as input data in accordance with predetermined conditions.

With this configuration, it is possible to perform flexible processing (operation advanced with inconsistency in the version numbers of the data handled in the preceding and succeeding processes known). For example, some process can temporarily use, as input data, the output data of the previous version in the upstream process and use the latest version thereof as input data afterward.

Although it is preferable that the input data include the data to serve as a processing target in the processes in the workflow management apparatus having the above configuration, the input data may include the data (operation manuals, etc.) to be referred to by processing in the process.

In the workflow management apparatus having the above configuration, the output data includes that divided into a plurality of sections and the process that uses the output data having a plurality of sections as input data defines one or more sections as input data.

As described above, only the necessary section in the output data including a plurality of sections is allowed to be defined as input data to be used in the downstream processes. Therefore, even when update occurs in output data including an enormous amount of information in some process, it is only necessary for the user such as process manager who uses the update output data to deal with the updated unit that relates to the process, contributing to reduction in work load and improvement in operational efficiency.

Further, in the workflow management apparatus having the above configuration, only when the state registration unit receives registration request indicating process completion from the users in charge of the processes and predetermined completion conditions of the target process are met, the state registration unit can perform completion registration of the target process.

This contributes to reduction in occurrence of human error. That is, it is possible to prevent users in charge of the processes from erroneously performing completion registration.

Further, in the workflow management apparatus having the above configuration, it is preferable that the state registration unit notify the user of a change of the process state at the time of changing registration contents. With this configuration, it is possible to automatically notify the user of the change of the process state, contributing to reduction in work load and improvement in operational efficiency in the workflow management task.

According to a second aspect of the present invention, there is provided a workflow management program that allows a computer to execute processing to manage a plurality of processes constituting a workflow, allowing the computer to execute: a process management step that allows each of the processes to perform processing based on input data of a currently acquired version number, the input data being used as the data related to processing in the processes; a version number acquisition step that acquires information related to version numbers of the input data in each of the processes and output data obtained as a processing result in each of the processes; and a state registration step that registers the state of each of the processes, wherein when the output data in any of the processes is updated, the state registration step resisters the state of the process including the updated output data in the input data thereof as “Being executed” based on the I/O information defining the input and output data and information related to the version number.

In the workflow management program having the above configuration, it is preferable that the process management step complete the entire processing of the workflow only when the version number of the output data in each process and the version number of the input data corresponding to the output data in the process that includes the output data as input data correspond to each other.

In the workflow management program having the above configuration, when the output data in any of the processes is updated, the state registration step may correspondingly update for registration the input data corresponding to the updated output data in the process that uses the updated output data as input data.

In the workflow management program having the above configuration, it is preferable that the process management step allow an arbitrary process to use previous version output data as input data in accordance with predetermined conditions.

Although it is preferable that the input data include the data to serve as a processing target in the processes in the workflow management program having the above configuration, the input data may include the data to be referred to by processing in the process.

Further, in the workflow management program having the above configuration, it is preferable that the output data include that divided into a plurality of sections and the process that uses the output data having a plurality of sections as input data define one or more sections as input data.

In the workflow management program having the above configuration, only when the state registration step receives registration request indicating process completion from the users in charge of the processes and predetermined completion conditions of the target process are met, the state registration step can perform completion registration of the target process.

In the workflow management program having the above configuration, it is preferable that the state registration step notify the user of a change of the process state at the time of changing registration contents.

According to a third aspect of the present invention, there is provided a workflow management method that manages a plurality of processes constituting a workflow, including: a process management step that allows each of the processes to perform processing based on input data of a currently acquired version number, the input data being used as the data related to processing in the processes; a version number acquisition step that acquires information related to version numbers of the input data in each of the processes and output data obtained as a processing result in each of the processes; and a state registration step that registers the state of each of the processes, wherein when the output data in any of the processes is updated, the state registration step resisters the state of the process including the updated output data in the input data thereof as “Being executed” based on the I/O information defining the input and output data and information related to the version number.

In the workflow management method having the above configuration, it is preferable that the process management step complete the entire processing of the workflow only when the version number of the output data in each process and the version number of the input data corresponding to the output data in the process that includes the output data as input data correspond to each other.

In the workflow management method having the above configuration, when the output data in any of the processes is updated, the state registration step may correspondingly update for registration the input data corresponding to the updated output data in the process that uses the updated output data as input data.

In the workflow management method having the above configuration, it is preferable that the process management step allow an arbitrary process to use previous version output data as input data in accordance with predetermined conditions.

Although it is preferable that the input data include the data to serve as a processing target in the processes in the workflow management method having the above configuration, the input data may include the data to be referred to by processing in the process.

Further, in the workflow management method having the above configuration, it is preferable that the output data include that divided into a plurality of sections and the process that uses the output data having a plurality of sections as input data define one or more sections as input data.

In the workflow management method having the above configuration, only when the state registration step receives registration request indicating process completion from the users in charge of the processes and predetermined completion conditions of the target process are met, the state registration step can perform completion registration of the target process.

In the workflow management method having the above configuration, it is preferable that the state registration step notify the user of a change of the process state at the time of changing registration contents.

It is possible to allow a computer that constitutes the workflow management apparatus to execute the workflow management program by storing the program in a computer-readable recording medium. Examples of the above computer readable recording medium include a CD-ROM, a flexible disk, a DVD disk, a magnetic optical disk, a portable recording medium including a semiconductor memory device such as an IC card, a fixed memory device such as an ROM, an RAM, or a magnetic recording device mounted in a computer, a database that holds computer program, another computer and database thereof, and a transmission medium on a network line.

As described above, each of the above steps in the workflow management method is realized by allowing a computer to execute the workflow management program.

As described above in detail, according to the present invention, there is provided a workflow management apparatus, workflow management program, and workflow management method that can contribute to automatization of the management task and increase in operational efficiency in the task involving high-level parallel operations.

### BRIEF DESCRIPTION OF THE DRAWINGS

FIG. 1 is a functional block diagram for explaining a workflow management apparatus according to an embodiment of the present invention;

FIG. 2 is a view showing an example of a workflow definition to be managed in the embodiment;

FIG. 3 is a view for explaining a process information table;

FIG. 4 is a view for explaining a process state management table;

FIG. 5 is a view for explaining a related information table;

FIG. 6 is a view for explaining a completion condition management table;

FIG. 7 is a view for explaining an input information table;

FIG. 8 is a view for explaining an output information table;

FIG. 9 is a view for explaining an output information management table;

FIG. 10 is a view for explaining a processed data information table;

FIG. 11 is a view for explaining an operation management table;

FIG. 12 is a view for explaining a reference data information table;

FIG. 13 is a view for explaining a reference data management table;

FIG. 14 is a flowchart for explaining a processing flow of an update data entry operation performed by the state registration unit;

FIG. 15 is a view showing an output information management table indicating a state where an updated design specification document has been registered;

FIG. 16 is a view for explaining the process state management table in which registered contents have been changed;

FIG. 17 is a flowchart for explaining creation processing of input data to be displayed an HTML GUI window performed by an HTML GUI creation unit;

FIG. 18 is a view showing an example of a display window displaying the created HTML GUI in an I/O terminal;

FIG. 19 is a flowchart for explaining creation processing of the HTML GUI window that displays operation items in each process performed by the HTML GUI creation unit;

FIG. 20 is a view showing an example of a display window displaying the created HTML GUI in an I/O terminal;

FIG. 21 is a view for explaining a predetermined completion condition defined with respect to the process;

FIG. 22 is a flowchart for explaining processing at the time when each process has been completed in the workflow;

FIG. 23 is a flowchart for explaining processing of setting back a state of check items to “UNCHECKED”;

FIG. 24 is a view for explaining a definition that is related to section information of the output data, the definition having been specified by a secyion management table;

FIG. 25 is a view showing a state where the input information table has been expanded and a column “reference section” has been added thereto;

FIG. 26 is a view showing a state where the output information management table has been expanded and a column “update version” has been added thereto; and

FIG. 27 is a flowchart for explaining processing performed in the case where the output data has been divided into sections.

### DETAILED DESCRIPTION OF THE PREFERRED EMBODIMENTS

An embodiment of the present invention will be described below with reference to the accompanying drawings.

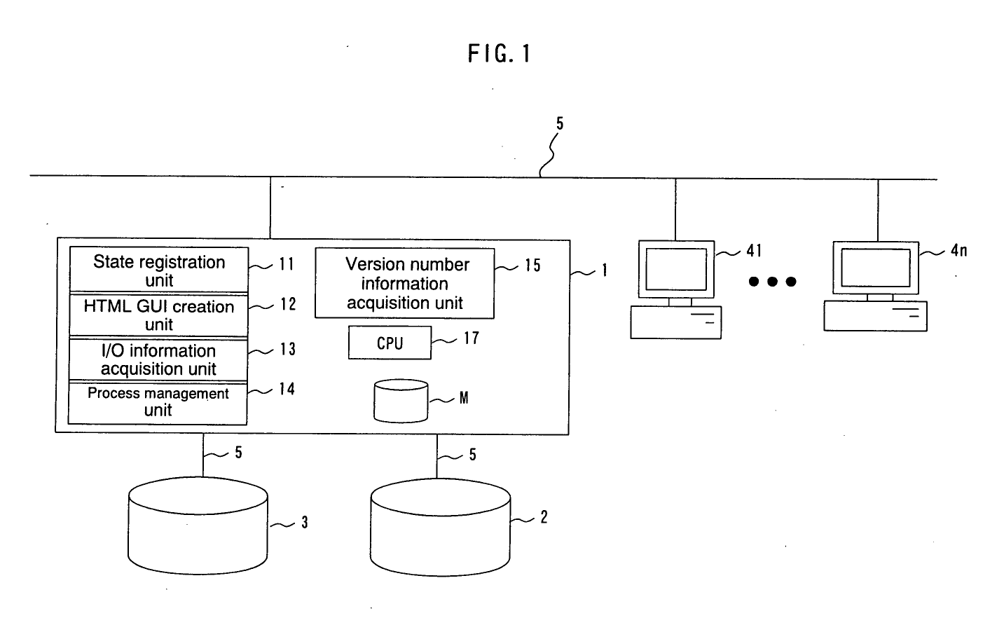

FIG. 1 is a functional block diagram for explaining a workflow management apparatus according to the embodiment of the present invention. The workflow management apparatus according to the embodiment performs management (so-called, workflow management) of a plurality of processes that constitute a workflow.

As shown in FIG. 1, the workflow management apparatus 1 according to the embodiment is connected, via a network (electric communication line) 5, to a process information database 2, a computerized document storage database 3, and I/O terminals 41 to 4n so as to be communicate with them.

The workflow management apparatus 1 includes a state registration unit 11, an HTML GUI creation unit 12, an I/O information acquisition unit 13, a process management unit 14, a version number information acquisition unit 15, a CPU (computer) 17, and storage unit (computer-readable recording medium) M.

The state registration unit 11 receives information input by a user through the I/O terminals 41 to 4n, registers design document data that have been created by the I/O terminals 41 to 4n in the computerized document storage database 3, performs registration processing with respect to the states of respective processes (for example, a processing state in the process, registration state of input and output data, or the like), and the like.

The HTML GUI creation unit 12 provides an HTML GUI to a user of the I/O terminals 41 to 4n.

The I/O information acquisition unit 13 acquires I/O information that defines output data obtained as a processing result and input data for use as the data related to processing in respective processes that constitute a workflow.

The process management unit 14 manages processing to be carried out in respective processes. The process management unit 14 allows processing to be performed in respective processes based on input data related to the version number that is currently held.

The version number information acquisition unit 15 acquires information related to the version number of input and output data in respective processes.

The CPU 17 executes various computations and programs in the workflow management apparatus 1. The storage unit M stores the program and the like executed by the CPU 17 and serves as a temporary storage area during the processing executed by the CPU 17.

With the above configuration, the workflow management apparatus 1 assumes a role of leading a user to an adequate process according to the workflow defined by the information stored in the process information database.

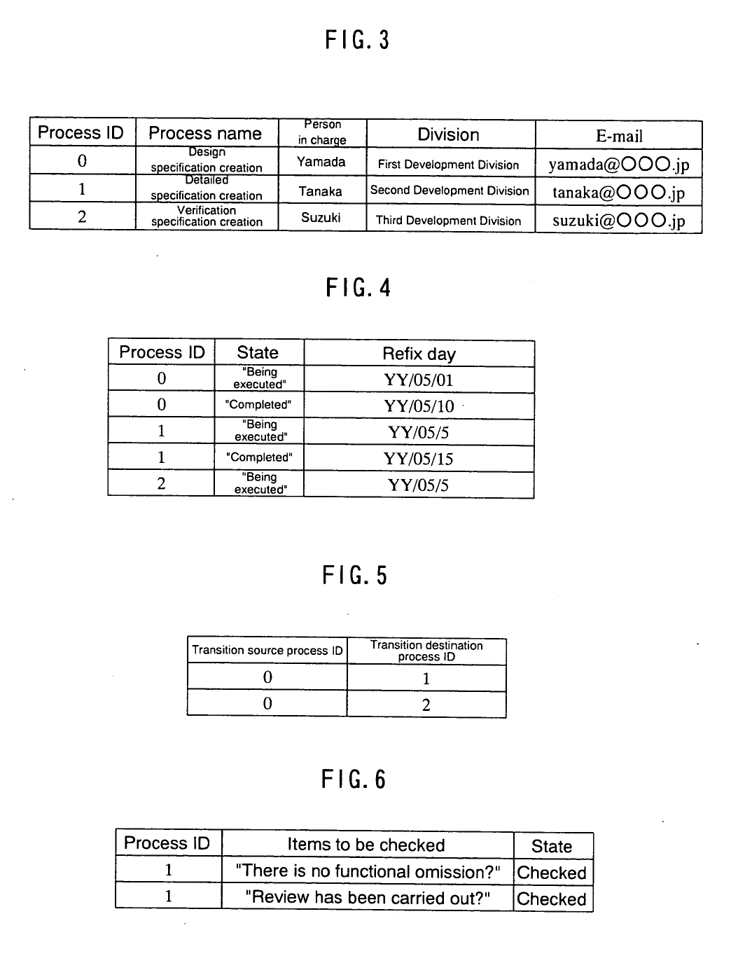

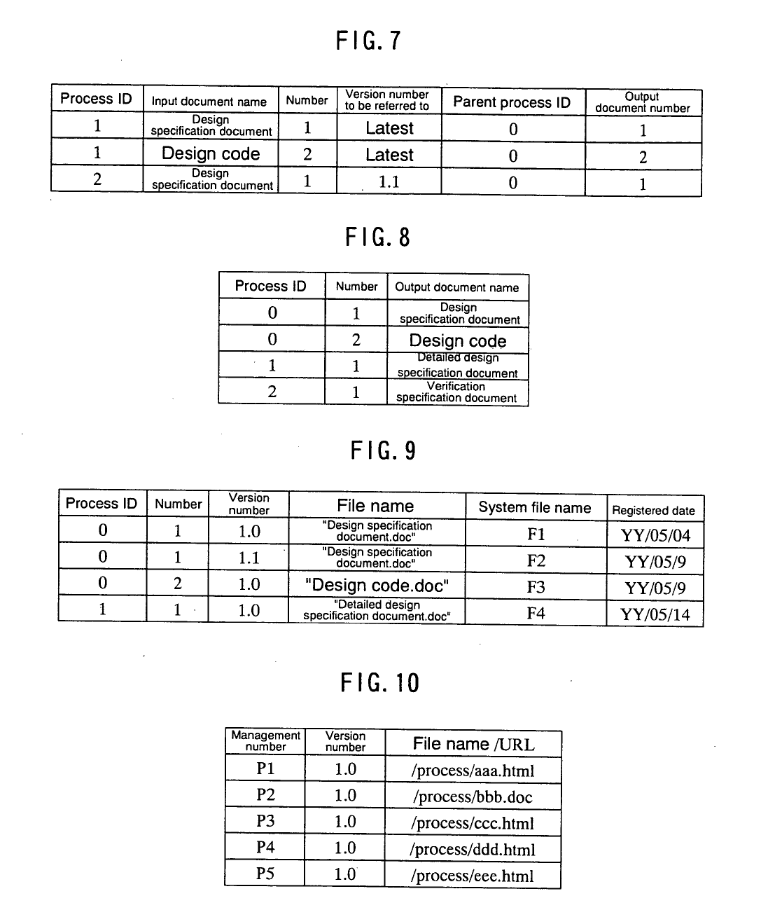

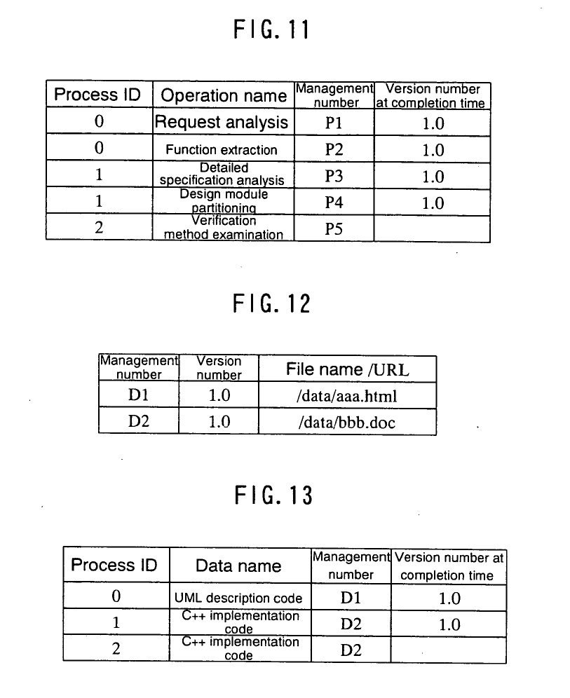

The process information database 2 stores information related to respective processes that constitute a workflow. The information related to the processes mentioned here includes: a process information table (FIG. 3) that defines name of each process, a person in charge of each process, a process ID and the like; a process state management table (FIG. 4) that defines a state of each process and refix date of the state; a related information table (FIG. 5) that defines relationship between adjacent processes; a completion condition management table (FIG. 6) that defines a completion condition of each process; an input information table (FIG. 7) that defines the contents, version number and the like of the data to serve as input data (information for use in processing) in each process; an output information table (FIG. 8) that defines the contents (corresponding to output data) of the data and the like to serve as output information (information obtained by processing in the process) in each process; an output information management table (FIG. 9) that manages the registration information of the output information; a processing data information table (FIG. 10) that defines the version number and location of the data to be processed in the operation in each process; an operation management table (FIG. 11) that defines correspondence between the operation and the data to be processed in each process and the like; a reference data information table (FIG. 12) that defines the version number and location of the data (the data to be referred to at the processing time in each process) such as operation manuals other than the data to be processed in each process; and a reference data management table (FIG. 13) that defines correspondence between the version number and management number of the data such as operation manuals to be referred to in each process and the process that referrers to the data. Here, the data to be processed in each process and data to be referred to at the processing time in each process correspond to the input data.

The computerized document storage database 3 stores the data to be processed in each process and data such as operation manuals to be referred to at the processing time.

Each of the I/O terminals 41 to 4n is constituted by, for example, a PC (Personal-Computer) and receives an input from a user. The I/O terminals 41 to 4n display information transmitted from the workflow management apparatus 1, acquire data from the computerized document storage database 3 through the workflow management apparatus 1, and transmit data to the workflow management apparatus 1 for data registration. The display of information on the I/O terminals 41 to 4n is realized by using, for example, a WWW-browser as a client program.

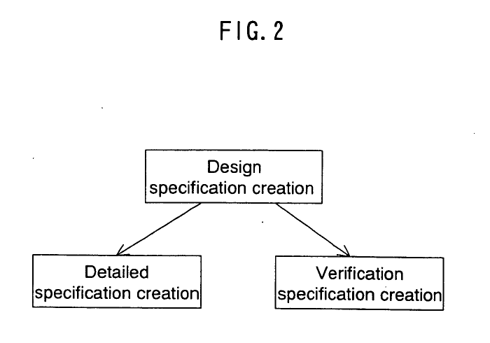

FIG. 2 is a view showing an example of a workflow definition to be managed in the present embodiment. As shown in FIG. 2, each process is represented by a square, and transition (processing flow) from one process to another is represented by an arrow that connects the processes. In this case, processing results obtained in a design specification creation process are utilized by a detailed specification creation process and a verification specification creation process.

The workflow shown in FIG. 2 is defined based on various data (refer to the tables shown in FIGS. 3 to 13) stored in the aforementioned process information database 2 and allows a plurality of processes to have order relations with each other along a task performance procedure. The workflow can include a flow going from a plurality of processes to one process in a concentrated manner or flow going from one process to a plurality of processes in a divergent manner.

In the following, a description will be given of the details of information related to the processes that define the workflow shown in FIG. 2 with reference to examples.

The process information table stores a process ID, name of each process, a person in charge of each process, a division and e-mail address of the person in charge (FIG. 3). Here, IDs of the design specification creation process, detailed specification creation process, and verification specification creation process are defined as “0”, “1”, and “2”, respectively. The information including the process name, person in charge, and the like are stored in association with the above IDs.

The process state management table stores a process ID, processing state of each process, refix date when the processing state has been updated (FIG. 4). As the processing state, states such as “Unstarted” “Being executed” “Completed” can be defined.

The related information table defines relationship (processing flow in the workflow) between adjacent processes (FIG. 5). Here, the design specification creation process having the process ID “0” is set as a transition source (upstream side in the workflow), and the detailed specification creation process having the process ID “1” and verification specification creation process having the process ID “2” are set as transition destinations (downstream side in the workflow).

The completion condition management table defines a completion condition (corresponding to a predetermined completion condition) of each process (FIG. 6). Here, it is necessary that items such as “there are no functional omission?”, “review has been carried out?” be checked in order to complete the processing in the detailed specification creation process. FIG. 6 shows a state where all items have been checked and the process can thus be completed.

The input information table stores the name and serial number of the data to serve as an input data (information for use in processing) in each process, version number to be referred to as input information, ID of the process that outputs the data, that is, the process that the data belongs to, and serial number of the data in the process that the data belongs to (FIG. 7). For example, it is defined in FIG. 7 that the detailed specification creation process uses a design specification document created in the design specification creation process for processing and always uses the latest design specification document. Note that it is possible to specify and use an older version design specification document as input data.

The output information table defines the contents (corresponding to output data) of the data and the like to serve as output data (information obtained by processing in the process) in each process (FIG. 8). As can be seen from FIG. 8, the design specification document and design code are created in the design specification creation process, for example.

The output information management table stores the registration information related to the output information in each process that has been registered in the computerized document storage database 3 (FIG. 9). As shown in FIG. 9, it can be seen that there are three output documents that has been registered in the computerized document storage database 3 with respect to, for example, the design specification creation process (process ID “0”), and that two versions of “design specification document.doc” are stored. Here, “design specification document.doc” of version number 1.0 has been registered with its system file name being “F1”, and “design specification document.doc” of version number 1.1 has been registered with its system file name being “F2”.

The processing data information table defines the version number and location of the data to be processed in the operation in each process (FIG. 10). It can be seen from FIG. 10 that the latest version number of the data having the management number P1 is 1.0 and address of the data is “/process/aaa.html”

The operation management table defines correspondence between the operation in each process and the data to be processed in the operation and the version number of the data to be processed that has been referred to at the operation completion time (FIG. 11).

The reference data information table defines the version number and location of the data (the data to be referred to at the processing time in each process) such as operation manuals other than the data to be processed in each process (FIG. 12). It can be seen from FIG. 12 that the latest version number of the data having the management number D1 is 1.0 and address of the data is “/data/aaa.html”

The reference data management table defines correspondence between the name, management number, and version number at the process completion time with respect to the data such as operation manuals to be referred to in each process and the process that referrers to the data (FIG. 13).

When the version numbers of the aforementioned data to be processed in the operation management table and reference data (corresponding to the output data from any of the plurality of processes) in the reference data information table are updated, the latest version number of the updated data is acquired by the version number information acquisition unit 15. The state registration unit 11 updates/registers the version number of the input data that has been held in the process to the acquired latest version number in corresponding with the updated data (state registration step). Therefore, even when the version number of the output data is updated in the process that lies on the upstream side of the workflow, it is possible to always keep the input data of the process that uses the updated output data as input data up to date. As a result, information related to design change or the like can be quickly reflected in the process on the downstream side, contributing to improvement in operational efficiency.

An operation of the workflow management apparatus 1 according to the present embodiment will next be described in detail. Here, it is assumed that the design specification document, which is output data of the design-specification creation process, is updated to version 1.2.

As shown in FIG. 4, the states of each process in the workflow shown in FIG. 2 are as follows: design specification creation process is “Completed”, detailed specification creation process is “Completed”, and verification specification creation process is “Being executed (processed)”. Further, as shown in FIG. 7, the detailed specification creation process refers to the design specification document and design code, which are output data of the design specification creation process, as input data.

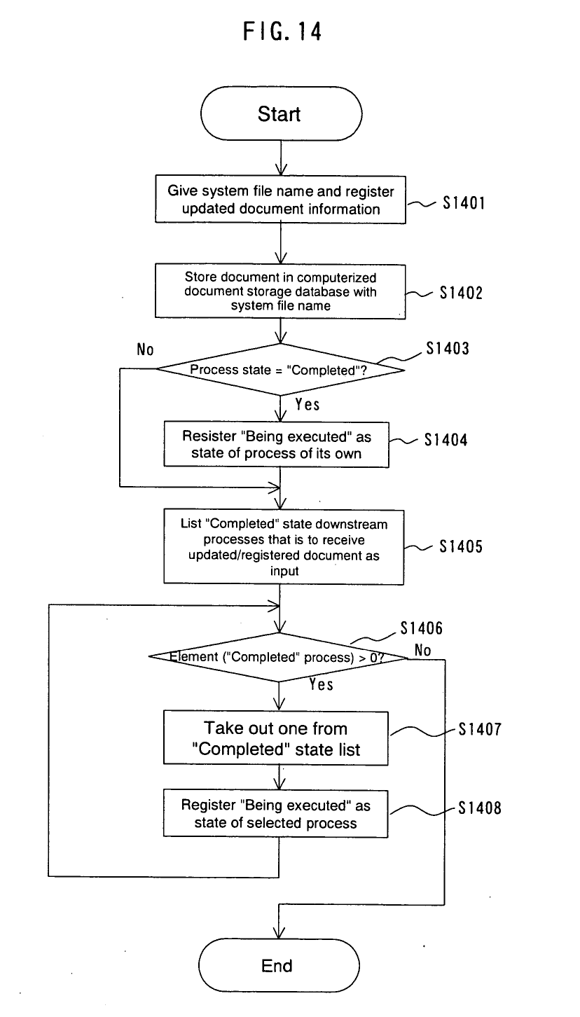

Firstly, a processing flow of an update data entry operation performed by the state registration unit 11 will be described with reference to the flowchart of FIG. 14.

In the workflow management apparatus 1 according to the present embodiment, a plurality of the processes that constitute the workflow are managed by the process management unit 14. The process management unit 14 allows processing to be performed based on the input data of the version number that has now been held in each process (process management step).

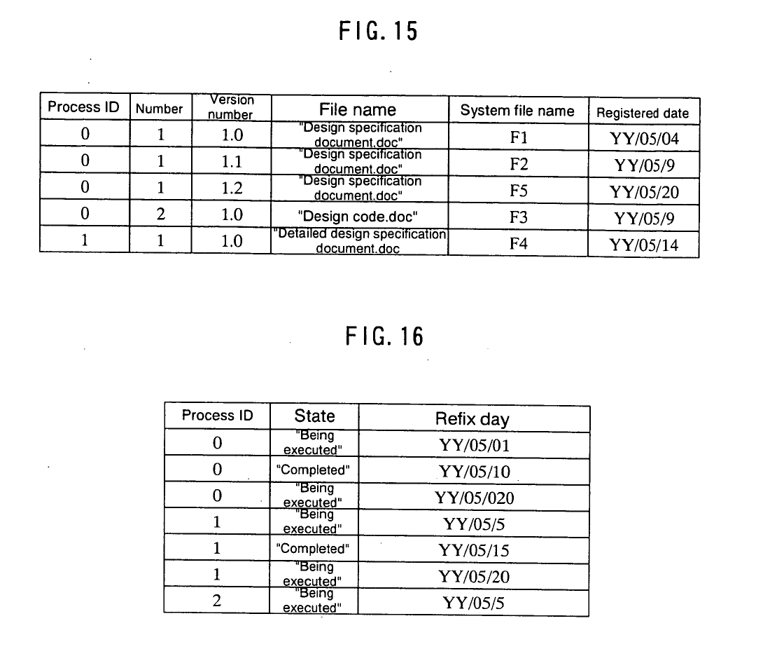

When an update data entry of the design specification document occurs, a file name unique in the system is given to the data and registered in the output information management table together with its original file name, registered date, and the like (S1401). FIG. 15 shows the output information management table indicating a state where the updated design specification document (version 1.2) has been registered. Whether the data of the design specification document has been updated is determined based on the information related to the version number to be acquired by the version number information acquisition unit 15 (version number acquisition step).

Next, the design specification document data is stored in the computerized document storage database 3 (S1402) with the system file name (F5) that has been given to the data in the aforementioned step.

Then, it is determined whether the state of the design specification creation process, which is the process that has created the updated design specification document, is “Completed” or “Being executed” (S1403). In this case, the state of the design specification creation process is “Completed” according to the assumption described above. Therefore, the flow proceeds to S1404 to register “Completed” in the process state management table to change the state of the design specification creation process (S1404) (state registration step).

Then, the “Completed” state downstream processes that include the updated design specification document as the input data thereof are listed (S1405), the processes being in the “Completed” state are taken out one by one from the list of “Completed” downstream processes (S1407), and “Being executed” is registered as the state of the taken out processes in the process state management table (S1408) until there is no more “Completed” state downstream process (S1406). Note that the relationship between the output data of the upstream process and input data of the downstream process in the aforementioned workflow is determined based on the I/O information acquired by the I/O information acquisition unit 13. Here, the detailed specification creation process is a target of registration. FIG. 16 shows the process state management table whose registered contents are modified by the aforementioned processing.

As described above, when the update of the output data occurs in any of the plurality of processes, the state registration unit 11 registers “Being executed” (state registration step) as the state of the process including the updated output data as the input data thereof based on the information related to the I/O information acquired by the I/O information acquisition unit 13 and the version number acquired by the version number information acquisition unit 15.

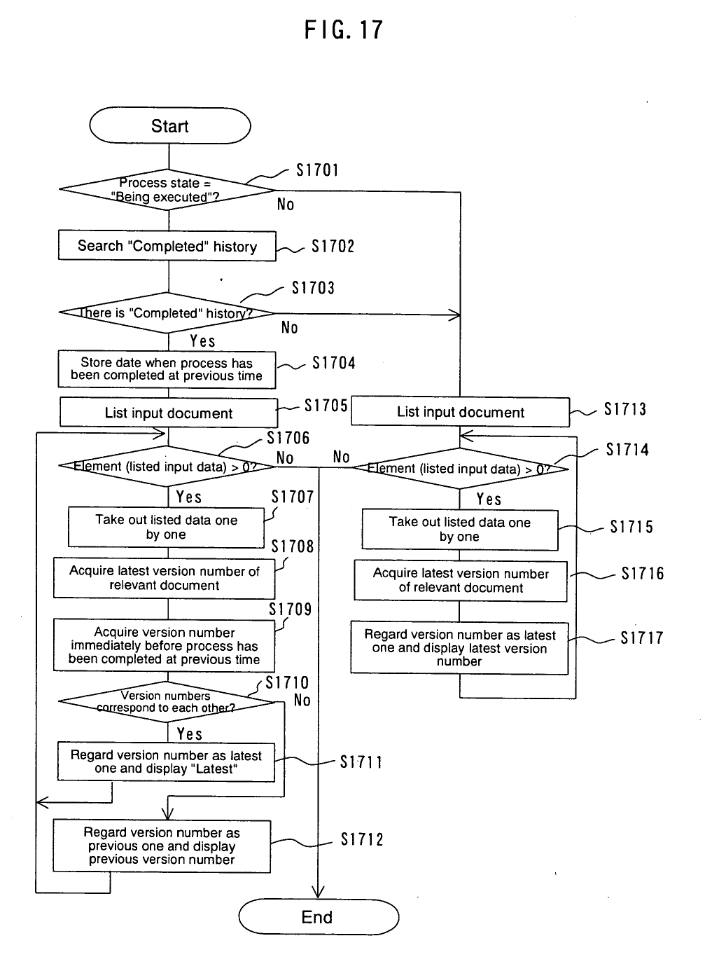

Next, creation processing of input data to be displayed in an HTML GUI window performed by the HTML GUI creation unit 12 will be described with reference to the flowchart of FIG. 17. Here, an HTML GUI window to be used by an I/O terminal in the detailed specification creation process is created. It is assumed that the detailed specification creation process is in the “Being executed” state (refer to FIG. 16).

Firstly, the state of the process is determined (S1701). In this case, the detailed specification creation process is in the “Being executed” state as shown in FIG. 16. Therefore, the flow proceeds to S1702 to search previous “Completed” histories with respect to the detailed specification creation process (S1702) (refer to FIG. 16). Since the ID of the detailed specification creation process is “1”, it can be seen from FIG. 16 that there is the “Completed” history (Yes in S1703), with the result that the flow proceeds to S1704.

In S1704, “YY/05/15”, which is the date when the detailed specification creation process has been completed at previous time, is stored in the storage unit M. Then, the data (input data) to be used for the processing in the detailed specification creation process are listed (S1705) with reference to the input information table (FIG. 7). As shown in FIG. 7, the input data to be used for the detailed specification creation process includes the design specification and design code.

The listed input data are taken one by one from the list (S1707) until there is no more listed input data (S1706) to acquire the latest version number of the input data acquired by the version number acquisition unit 15 (S1708). In this case, the latest version number of the design specification is 1.2 (refer to FIG. 15).

Subsequently, the version number information acquisition unit 15 acquires the version number immediately before the date when the detailed specification creation process has been completed at previous time with respect to the input data (design specification) whose latest version number has been acquired in the aforementioned step (S1708). In this case, the version number immediately before the date when the detailed specification creation process has been completed at previous time is 1.1 (refer to FIG. 15).

Then the version number immediately before the date when the detailed specification creation process has been completed at previous time and the latest version number are compared with each other (S1710). When the version numbers correspond to each other (Yes in S1710), the HTML GUI is allowed to display “Latest” with the version number of the design specification currently used as input data regarded as the latest one.

When the version numbers do not correspond to each other (No in S1710), the version number of the design specification currently used as input data is regarded as the previous one to allow the HTML GUI to display a previous version number (S1712). Thereafter, the flow shifts to the comparison processing to compare the version numbers of a pair of another input data (S1706).

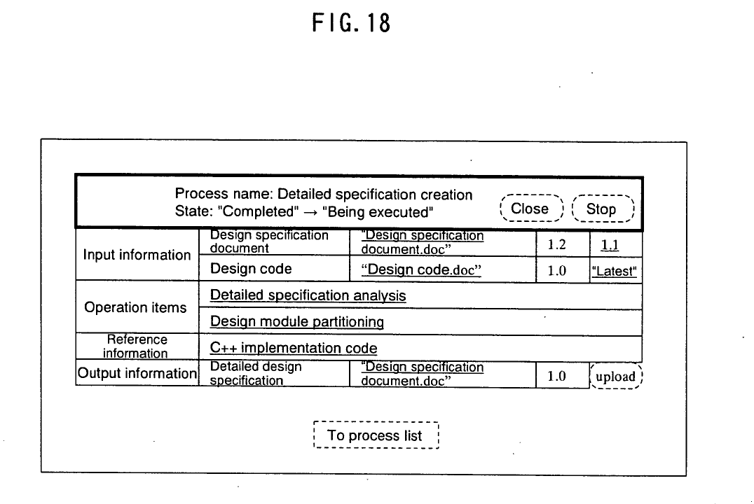

When the detailed specification creation process is not in the “Being executed” state (No in S1701) or there is no “Completed” history (No in S1703), the latest version number with respect to all the input data used in the detailed specification creation process is acquired to allow the HTML GUI to display “Latest” as the version number of each input data (S1713 to S1717). FIG. 18 shows an example of the display window using the HTML GUI created by the above processing in the I/O terminal.

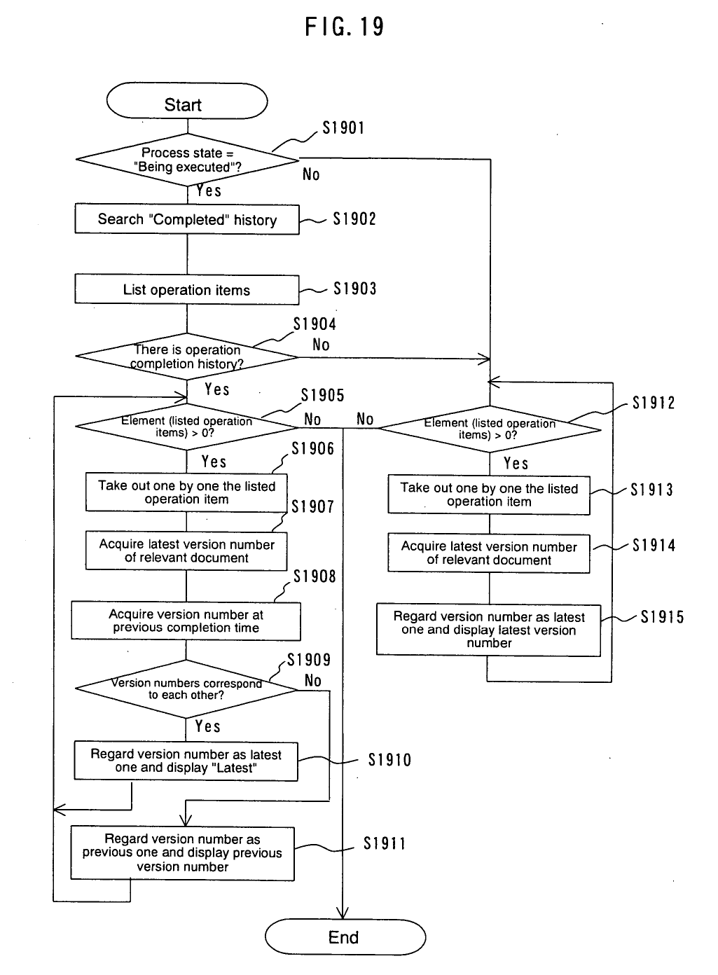

Next, creation processing of the HTML GUI window that displays operation items in each process performed by the HTML GUI creation unit 12 will be described with reference to the flowchart of FIG. 19. It is assumed that when the state of the processing in each process is changed to “Completed” by the state registration unit 11, the latest version number of the data to be processed is acquired from the processing data information table (FIG. 10) and registered, at the completion time of each operation, in the column of “version number at completion time” of the operation management table (FIG. 11).

Firstly, the process state is determined (S1901). In this case, the state of the detailed specification creation process is “Being executed” as shown in FIG. 16. Therefore, the flow proceeds to S1902 to search previous “Completed” histories with respect to the detailed specification creation process (S1902) (refer to FIG. 16).

Then, operation items in the detailed specification creation process are listed (S1903) (refer to FIG. 11).

Subsequently, it is determined whether there is a history indicating that operation has been completed in the listed operation items (S1904). When there is the operation completion history in the listed operation items (Yes in S1904), the listed operation items are taken out (S1906) one by one from the list until there is no listed operation items (S1905) to acquire the latest version number of the processing data in the operation items that is acquired by the version number information acquisition unit 15 (S1907) (refer to FIG. 10).

Then, the version number information acquisition unit 15 acquires (S1908) the version number of the operation item at the previous completion time with respect to the processing data whose latest version number has been acquired by the abovementioned step (S1907).

Subsequently, the version number of the operation item at the previous completion time and the latest version number are compared with each other (S1909). When the version numbers correspond to each other (Yes in 1909), the HTML GUI is allowed to display “Latest” with the version number of the processing data currently used regarded as the latest one (S1910).

When the version numbers do not correspond to each other (No in S1909), the version number of the processing data currently used is regarded as the previous one to allow the HTML GUI to display a previous version number (S1911). Thereafter, the flow shifts to the comparison processing to compare the version numbers of a pair of another processing data (S1905).

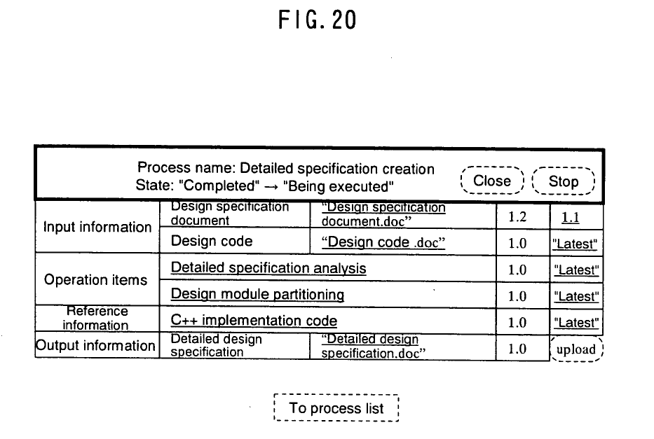

When the detailed specification creation process is not in the “Being executed” state (No in S1901) or there is no operation completion history (No in S1904) in the listed operation items, the latest version number with respect to all the processing data used in the detailed specification creation process is acquired to allow the HTML GUI to display “Latest” as the version number of each processing data (S1912 to S1915). FIG. 20 shows an example of the display window using the HTML GUI created by the above processing in the I/O terminal. Note that the same processing as that shown in the flowchart of FIG. 19 is applied to reference data (the data that does not become processing result in each process, such as the data for definition of the operation procedure or manual of the tools used in the operation) such as operation manuals.

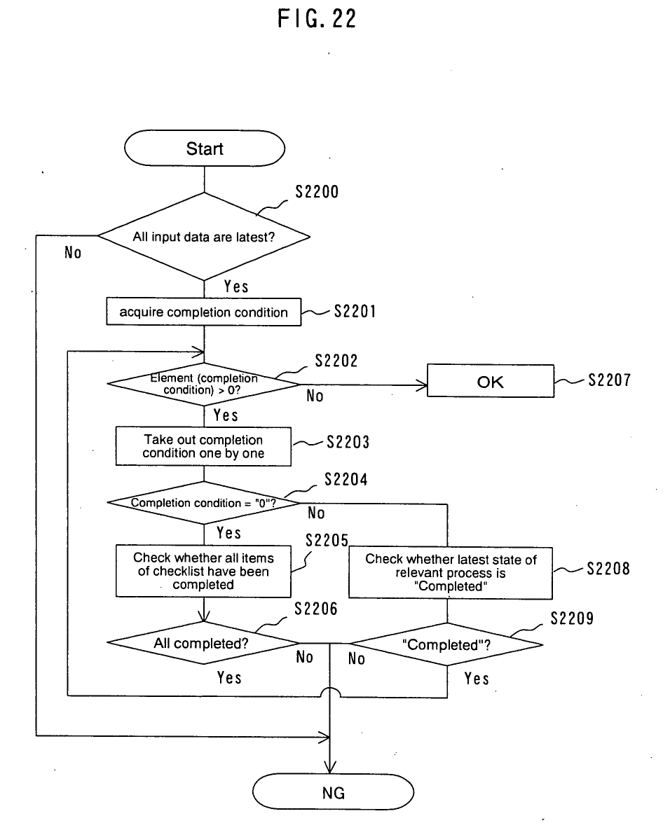

The processing performed at the completion time of each process in the workflow will next be described with reference to the flowchart of FIG. 22. Here, the processing performed at the completion time of the detailed specification creation process will be described as an example.

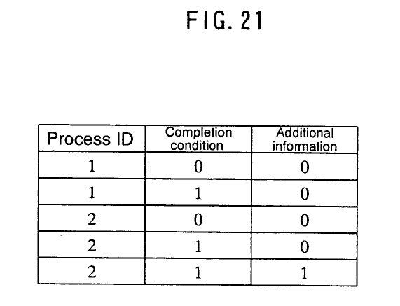

When the state registration unit 11 receives a registration request for the completion of the detailed specification creation process from a user (for example, process manager) through the I/O terminals 41 to 4n, firstly the version number acquisition unit 15 acquires the version number of input data in the process and determines whether all the acquired version numbers are the latest ones (S2200). Then, the state registration unit 11 acquires a predetermined completion condition (refer to FIG. 21) defined for the process (S2201). In FIG. 21, completion condition “0” means that “checklist has been filled in”, more specifically, all the completion conditions for the process shown in, for example, FIG. 6 have been met. On the other hand, completion condition “1” means that “process of the relevant ID has been completed previously”. Further, additional information “0” indicates that the ID of the relevant process is “0”. Similarly, additional information “1” indicates that the ID of the relevant process is “1”.

In this case, it can be seen that the predetermined completion condition defined for the detailed specification creation process is completion of the check list and the process having ID=“0”. Subsequently, the acquired completion conditions are determined one by one in the manner as described above (S2202, S2203). When the completion condition is “0 (all items of the checklist have been filled in)” (Yes in S2204), it is checked whether all items of the checklist of FIG. 6 have been filled in (S2205). When all the items of the checklist have been completed as shown in FIG. 6 (Yes in S2206), another completion condition that has been acquired in the aforementioned step (S2201) is checked (S2202).

When the completion condition is “1 (process having the relevant ID has been previously completed)” (No in S2204), it is checked whether the latest state of the process having the relevant ID is “Completed” with reference to the additional information (S2208). When the state is “Completed” (Yes in S2209), another completion condition that has been acquired in the aforementioned step (S2201) is checked (S2202). In this case, however, the design specification creation process is now in the “Being executed” state (refer to FIG. 16). Therefore, the detailed specification creation process cannot be completed.

When the aforementioned processing is performed and all the completion conditions of the target process are met, the state registration unit 11 performs completion registration of the target process (corresponding to state registration step). This contributes to reduction in occurrence of human error. That is, it is possible to prevent users such as process managers or the like in a plurality of processes from erroneously performing completion registration. At the time point when all the states of the processes in the workflow have been “Completed”, the process management unit 14 recognizes that “version numbers of input data and output data correspond to each other throughout the workflow” and completes the entire processing in the workflow.

The version number information acquisition unit 15 in the workflow management apparatus according to the present embodiment acquires the version numbers of input and output data in each process periodically or at a predetermined timing to check whether the data has been updated or not.

In the present embodiment, when the output data in the process of “Completed” state is updated and registered, or the version number of the input data in the downstream process is changed due to the update of the output data in the upstream process, the state registration unit 11 automatically changes the state of the processes that come under the influence of the update to, for example, “Being executed” and changes “state” column of the checklist (refer to FIG. 6) to “Unchecked” to meet the completion condition so that the state of process is not changed from “Being executed” to another state.

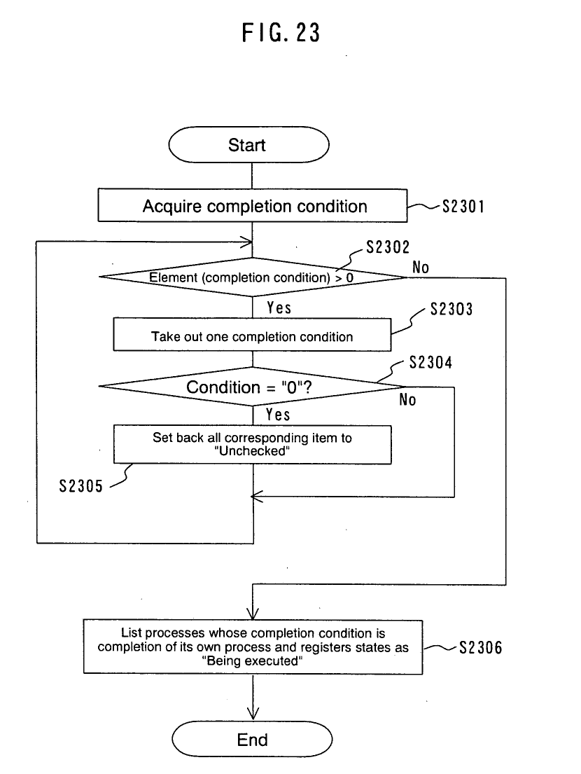

FIG. 23 is a flowchart for explaining the processing to set back the aforementioned check item to “Unchecked” state.

When there has occurred a registration of updated output data, or change of the version number of input data in some process, the state registration unit 11 acquires the completion conditions of the relevant process (S2301) to determine one by one, with respect to each of the acquired completion conditions, whether it indicates “all items of the checklist has been completed” (S2302 to S2304).

When there is the completion condition indicating “all items of the checklist has been completed”, the state registration unit 11 sets back corresponding “state” column of the checklist (FIG. 6) to “Unchecked” (S2305).

Finally (No in S2302), the state registration unit 11 lists the processes (the process in which there has occurred a registration of updated output data or change of the version number of input data) that come under the influence of the update from the processes whose registration state has been “Completed” and changes the states thereof to “Being executed” (S2306).

When the state of each process in the process state management table is changed from “Completed” to “Being executed”, the state registration unit 11 issues, at the time of occurrence of the change, a notification of the state change to the process personnel (corresponding to a user related to the process) by means of e-mail or the like (state registration step) except the case where the user seizes the update of data as in the case of S1404 in FIG. 14. With this configuration, it is possible to automatically notify the user of the change of the process state, contributing to reduction in work load and improvement in operational efficiency in the workflow management task.

Further, in the present embodiment, it is possible to specify, not the latest version number of reference input data, but a particular version number (for example, version number 1.1 of the design specification) (corresponding to a predetermined condition) as shown in the input information table of FIG. 7. With this configuration, the process management unit 14 allows the previous version number of output data to be used as the input data in an arbitrary process (process management step). In other words, the process in which a particular version number has been specified for input data does not receive update data entry of the input data. The aforementioned specification of the version number of input data can be performed as follows. That is, as shown in FIG. 18, a hyperlink is inserted into a version number of the input information displayed on the HTML GUI, and the user follows the link to a version number setting window where the user can specify a particular version number. As a matter of course, a button or the like for allowing the version number setting window as described above to be displayed may be provided on the HTML GUI.

With this configuration, it is possible to perform flexible processing (operation advanced with inconsistency in the version numbers of the data handled in the preceding and succeeding processes known). For example, some process can temporarily use, as input data, the output data of the previous version in the upstream process and use the latest version thereof as input data afterward.

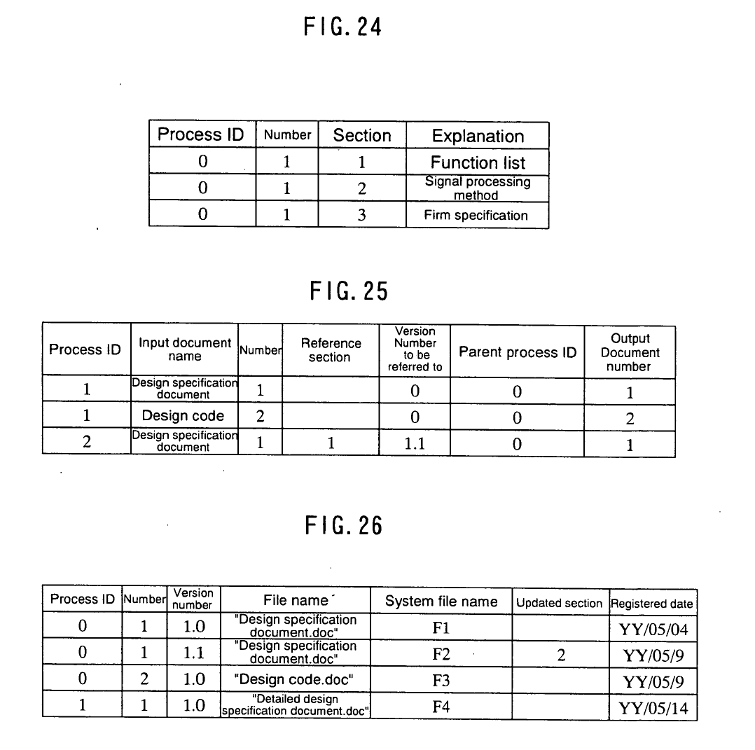

Further, the output data obtained as a processing result in each process within the workflow may be divided into a plurality of sections. More specifically, section information of output data is defined based on the information of the section management table (refer to FIG. 24). In FIG. 24, the design specification (serial number 1), which is output data of the design specification creation process (ID=0), is divided into three sections: a function list (section 1), a signal processing method (section 2), and a firm specification (section 3).

A column of “reference section” is added to the input information table (refer to FIG. 7) as shown in FIG. 25, and a column of “updated section” is added to the output information management table (refer to FIG. 9) as shown in FIG. 26, thereby allowing specification for each section.

That is, the process that uses the output data having a plurality of sections as input data can define one or more sections as input data. For example, it is assumed the state registration unit 11 performs the update data entry of output data, and the updated section of the output data is specified. In this case, only the “Completed” process including the updated section serving as input data is determined as the area that comes under the influence of the update, and the state of the relevant process is changed and registered.

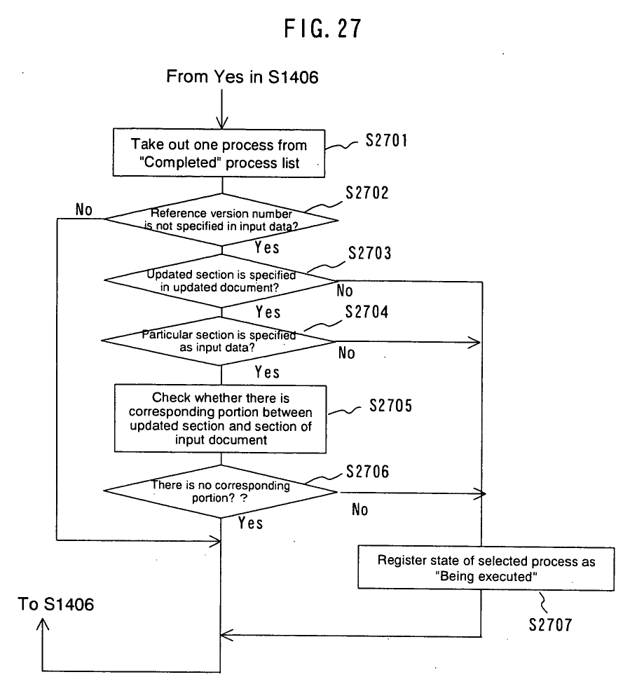

The processing performed in the case where output data is divided into a plurality of sections as described above will be described with reference to a flowchart of FIG. 27. The processing according to the flowchart of FIG. 27 corresponds to that of S1407 and S1408 in FIG. 14. The processing steps before S2701 and after S2706 and 2707 are the same as the processing according to the flowchart of FIG. 14 and the description thereof will be omitted.

The processes whose registration state is “Completed” of the downstream processes including the update data as input data are taken one by one from the list (S2701). Then, it is determined whether the version number to be referred to is specified with respect to the updated data (S2702). When the version number to be referred to is specified (that is, when the data of the previous version is referred to) (No in S2702), the flow moves to the determination of another process (S1406).

When the version number to be referred to is not specified (Yes in S2702), it is determined whether only a particular section of the updated data has been updated (S2703). When the data has been wholly updated (update has been made not only for a particular section but for another section) (No in S2703), the state of the taken out process that is being determined is registered as “Being executed” (S2707).

When only a particular section of the data has been updated (Yes in S2703), it is determined whether the process that uses the relevant data as input data specifies only a particular section as input data (S2704). In the above determination, when the process does not specify only a particular section as input data (No in S2704), the state of the taken out process that is being determined is registered as “Being executed” (S2707). When the process specifies only a particular section as input data (Yes in S2704), it is checked whether there is a corresponding portion between the updated section and the section specified as input data (S2705).

When there is a corresponding portion in the above determination (No in S2706), the state of the taken out process that is being determined is registered as “Being executed” (S2707). When there is no corresponding portion (Yes in S2706), the flow moves to the determination of another process (S1406).

As described above, only the necessary section in the output data including a plurality of sections is allowed to be defined as input data to be used in the downstream processes. Therefore, even when update occurs in output data including an enormous amount of information in some process, it is only necessary for the user such as process manager who uses the update output data to deal with the updated section that relates to the process, contributing to reduction in work load and improvement in operational efficiency.

Further, throughout the entire workflow, the process management unit 14 manages a plurality of processes that constitute the entire workflow such that the entire processing of the workflow is completed only when the version number of the output data in each process and the version number of the input data corresponding to the output data in the process that uses the output data as input data correspond to each other (process management step).

With this configuration, even when processing of each process is advanced with inconsistency in the version number of the output data and the version number of the input data corresponding to the output data in the process that uses the output data as input data known, it is possible to assure consistency between the version numbers in each process throughout the workflow in the last result.

As described above, according to the present embodiment, it is possible to realize workflow management that performs high-level parallel operations in which consecutive processes on the upstream and downstream sides are allowed to go ahead simultaneously by allowing each process to perform processing based on the input data of a currently acquired version number. Further, it is possible to flexibly cope with the case where inconsistency is present in the version numbers of the data used between processes, contributing to automatization of the management task and increase in operational efficiency in the task involving high-level parallel operations.

What is claimed is:

1. A workflow management apparatus that manages a plurality of processes constituting a workflow, comprising:
an I/O information acquisition unit that acquires I/O information defining, in each of the processes, output data obtained as a processing result and input data serving as the data related to processing;
a process management unit that allows each of the processes to perform processing based on input data of a currently acquired version number;
a version number acquisition unit that acquires information related to version numbers of the input and output data handled in each of the processes; and
a state registration unit that registers the state of each of the processes, wherein
when the output data in any of the processes is updated, the state registration unit resisters the state of the process including the updated output data in the input data thereof as “Being executed” based on the information related to the acquired I/O information and version number.

2. The workflow management apparatus according to claim 1, wherein the process management unit completes the entire processing of the workflow only when the version number of the output data in each process and the version number of the input data corresponding to the output data in the process that includes the output data as input data correspond to each other.

3. The workflow management apparatus according to claim 1, wherein, when the output data in any of the processes is updated, the state registration unit correspondingly updates for registration the input data corresponding to the updated output data in the process that uses the updated output data as input data.

4. The workflow management apparatus according to claim 1, wherein the process management unit allows an arbitrary process to use previous version output data as input data in accordance with predetermined conditions.

5. The workflow management apparatus according to claim 1, wherein the input data includes the data to serve as a processing target in the processes.

6. The workflow management apparatus according to claim 1, wherein the input data includes the data to be referred to by processing in the process.

7. The workflow management apparatus according to claim 1, wherein
the output data includes that divided into a plurality of sections, and
the process that uses the output data having a plurality of sections as input data defines one or more sections as input data.

8. A workflow management program that allows a computer to execute processing to manage a plurality of processes constituting a workflow, allowing the computer to execute:
a process management step that allows each of the processes to perform processing based on input data of a currently acquired version number, the input data being used as the data related to processing in the processes;
a version number acquisition step that acquires information related to version numbers of the input data in each of the processes and output data obtained as a processing result in each of the processes; and
a state registration step that registers the state of each of the processes, wherein
when the output data in any of the processes is updated, the state registration step resisters the state of the process including the updated output data in the input data thereof as “Being executed” based on the I/O information defining the input and output data and information related to the version number.

9. The workflow management program according to claim 8, wherein the process management step completes the entire processing of the workflow only when the version number of the output data in each process and the version number of the input data corresponding to the output data in the process that includes the output data as input data correspond to each other.

10. The workflow management program according to claim 8, wherein, when the output data in any of the processes is updated, the state registration step correspondingly updates for registration the input data corresponding to the updated output data in the process that uses the updated output data as input data.

11. The workflow management program according to claim 8, wherein the process management step allows an arbitrary process to use previous version output data as input data in accordance with predetermined conditions.

12. The workflow management program according to claim 8, wherein the input data includes the data to serve as a processing target in the processes.

13. The workflow management program according to claim 8, wherein the input data includes the data to be referred to by processing in the process.

14. The workflow management program according to claim 8, wherein
the output data includes that divided into a plurality of sections, and
the process that uses the output data having a plurality of sections as input data defines one or more sections as input data.

15. A workflow management method that manages a plurality of processes constituting a workflow, comprising:
a process management step that allows each of the processes to perform processing based on input data of a currently acquired version number, the input data being used as the data related to processing in the processes;
a version number acquisition step that acquires information related to version numbers of the input data in each of the processes and output data obtained as a processing result in each of the processes; and
a state registration step that registers the state of each of the processes, wherein
when the output data in any of the processes is updated, the state registration step resisters the state of the process including the updated output data in the input data thereof as “Being executed” based on the I/O information defining the input and output data and information related to the version number.

16. The workflow management method according to claim 15, wherein the process management step completes the entire processing of the workflow only when the version number of the output data in each process and the version number of the input data corresponding to the output data in the process that includes the output data as input data correspond to each other.

17. The workflow management method according to claim 15, wherein, when the output data in any of the processes is updated, the state registration step correspondingly updates for registration the input data corresponding to the updated output data in the process that uses the updated output data as input data.

18. The workflow management method according to claim 15, wherein the process management step allows an arbitrary process to use previous version output data as input data in accordance with predetermined conditions.

19. The workflow management method according to claim 15, wherein the input data includes the data to serve as a processing target in the processes.

20. The workflow management method according to claim 15, wherein the input data includes the data to be referred to by processing in the process.

21. The workflow management method according to claim 15, wherein
the output data includes that divided into a plurality of sections, and
the process that uses the output data having a plurality of sections as input data defines one or more sections as input data.
